(19) United States
(12) Patent Application Publication
(10) Pub. No.: US 2018/0046992 A1
(43) Pub. Date: Feb. 15, 2018

(54) SYSTEMS AND METHODS FOR ACCOUNT RECONCILIATION USING A DISTRIBUTED LEDGER

(71) Applicant: JPMorgan Chase Bank, N.A., New York, NY (US)

(72) Inventors: Kevin T. HANRAHAN, Evanston, IL (US); Daniel K. CHAU, Naperville, IL (US); Patrick CHIU, Chicago, IL (US); Lance CALAMITA, Chicago, IL (US); David John WALSH, Winnetka, IL (US); Tommy Weihua ZHU, Naperville, IL (US)

(21) Appl. No.: 15/233,719

(22) Filed: Aug. 10, 2016

(51) Int. Cl. G06Q 20/06

(52) U.S. Cl. CPC G06Q 20/0658

(57) ABSTRACT

Systems and methods for account reconciliation using a distributed ledger are disclosed. In one embodiment, a method for account reconciliation using a distributed ledger may include: (1) a payment sending financial institution receiving a transaction involving an account maintained by the payment sending financial institution for a payment receiving financial institution; (2) the payment sending financial institution communicating the transaction to the payment receiving financial institution using a transaction network; (3) the payment sending financial institution writing the transaction as a first ledger entry to the payment sending financial institution's copy of a distributed transaction ledger; (4) the payment sending financial institution receiving a second ledger entry from the payment receiving financial institution; and (5) the payment sending financial institution reconciling the account using the first ledger entry and the second ledger entry.

### BACKGROUND OF THE INVENTION

### 1. Field of the Invention

The present disclosure generally relates to systems and methods for account reconciliation using a distributed ledger.

### 2. Description of the Related Art

In order to support the Foreign Exchange Market and transact in foreign currencies, banks maintain nostro accounts with their partner banks in other countries. The volume on these accounts is substantial so it is important to reconcile and control this activity to avoid accounts being overdrawn and manage the risk of being long or short in a particular currency.

### SUMMARY OF THE INVENTION

Systems and methods for account reconciliation using a distributed ledger are disclosed. In one embodiment, a method for account reconciliation using a distributed ledger may include: (1) a payment sending financial institution receiving a transaction involving an account maintained by the payment sending financial institution for a payment receiving financial institution; (2) the payment sending financial institution communicating the transaction to the payment receiving financial institution using a transaction network; (3) the payment sending financial institution writing the transaction as a first ledger entry to the payment sending financial institution's copy of a distributed transaction ledger; (4) the payment sending financial institution receiving a second ledger entry from the payment receiving financial institution; and (5) the payment sending financial institution reconciling the account using the first ledger entry and the second ledger entry.

In one embodiment, the first ledger entry may include a smart contract. The smart contract may include instructions for the payment sending financial institution to match the first ledger entry to the second ledger entry.

In one embodiment, the smart contract may include an opening balance for the account and/or instructions to alert the sending financial institution in response to a reconciliation failure.

In one embodiment, the first ledger entry may include a credit entry for the account.

In one embodiment, the second ledger entry may include a debit entry for the account.

In one embodiment, the account may be a nostro account.

In one embodiment, the distributed ledger may be a blockchain distributed ledger.

According to another embodiment, a method for account reconciliation using a distributed ledger may include (1) a payment receiving financial institution receiving a transaction involving an account maintained by a payment sending financial institution for the payment receiving financial institution over a transaction network; (2) the payment receiving financial institution writing the transaction as a first ledger entry to the payment receiving financial institution's copy of a distributed transaction ledger; (3) the payment receiving financial institution receiving a second ledger entry from the payment second financial institution; and (4) the payment receiving financial institution reconciling the account using the first ledger entry and the second ledger entry.

In one embodiment, the first ledger entry may include a smart contract. The smart contract may include instructions for the payment sending financial institution to match the first ledger entry to the second ledger entry.

In one embodiment, the smart contract may include an opening balance for the account and/or instructions to alert the sending financial institution in response to a reconciliation failure.

In one embodiment, the first ledger entry may include a credit entry for the account.

In one embodiment, the second ledger entry may include a debit entry for the account.

In one embodiment, the account is a nostro account.

In one embodiment, the distributed ledger may be a blockchain distributed ledger.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for account reconciliation using a distributed ledger according to one embodiment; and

FIG. 2 depicts a method for account reconciliation using a distributed ledger according to one embodiment.

### DETAILED DESCRIPTION OF PREFERRED EMBODIMENTS

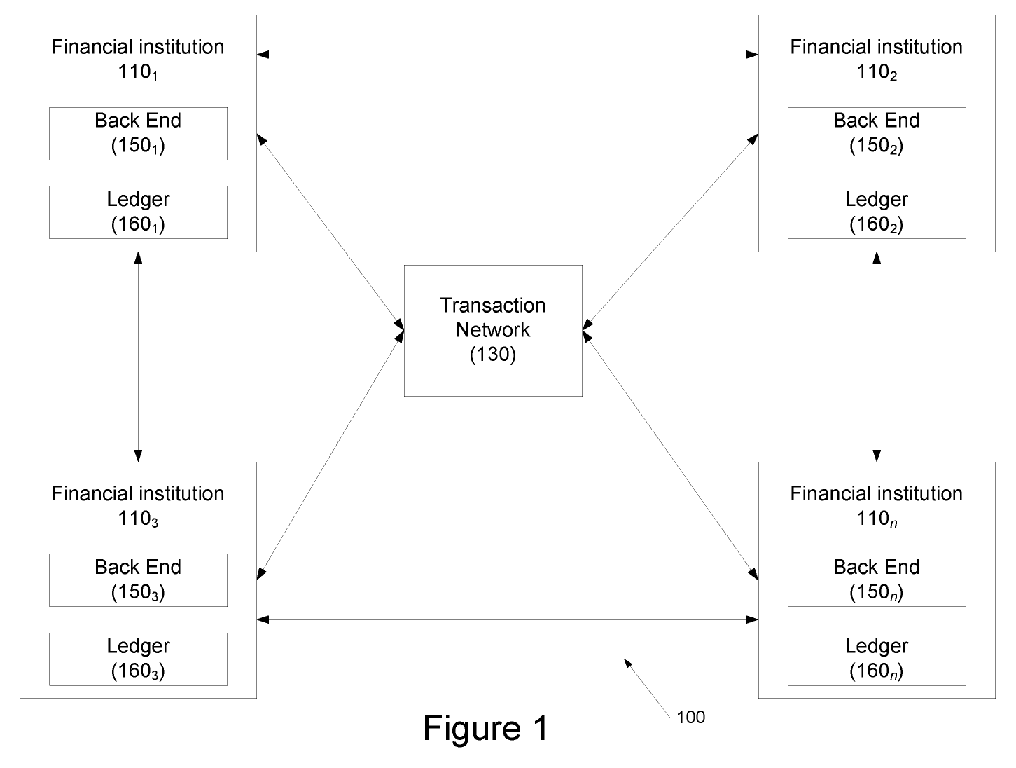

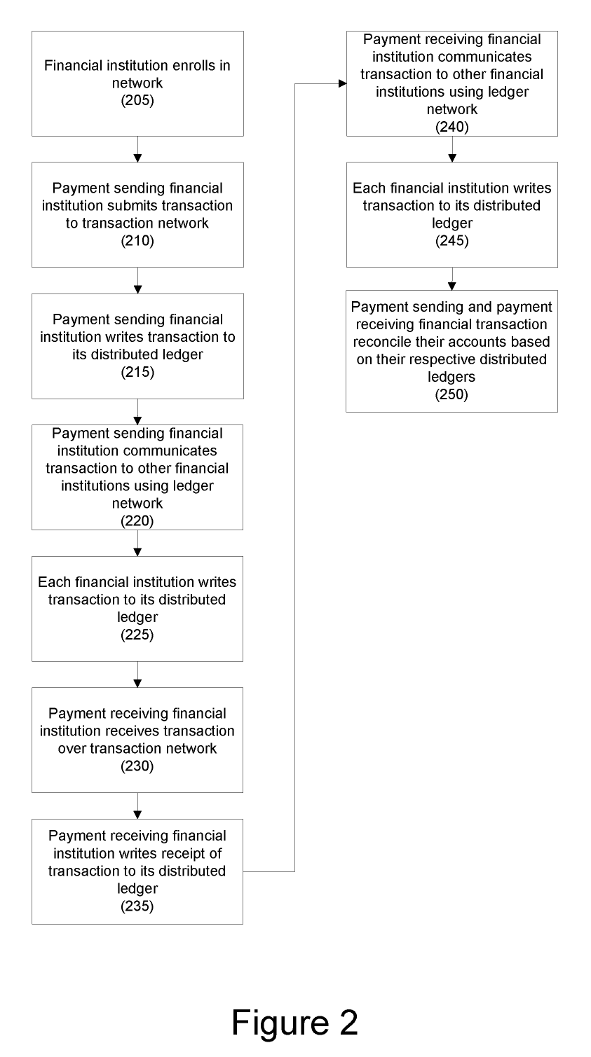

Several embodiments of the present invention and their advantages may be understood by referring to FIGS. 1-2.

Embodiments are directed to account reconciliation using a distributed ledger.

Most financial institutions receive Nostro account statements from their Nostro agents through the Society for Worldwide Interbank Financial Telecommunication, or SWIFT, network. The nostro statement entries are then reconciled against mirror account entries maintained in the bank. The financial institution will generally take remedial action immediately in case of mismatch is found in the transaction entries.

There is no visibility of Nostro account balances during the day as statements are received and reconciled at end of day. Thus, the financial institution cannot track, detect and/or resolve transaction errors until statement is received at end of day.

Non-SWIFT financial institutions receive statements by fax or email, which will cause further delay and lead to errors in reconciliation.

Embodiments disclose a system and method whereby nostro agent financial institution and client financial institution may use a distributed ledger in order to reconcile transactions substantially in real time. An example of such a distributed ledger is a Blockchain-based ledger, which contains blocks that hold timestamped batches of valid transactions. Each block may include the hash of the prior block, linking the blocks together. The linked blocks form a chain, with each additional block reinforcing those before it.

In one embodiment, the distributed ledger may be the Ethereum platform.

In one embodiment, the system and method may provide real-time reconciliation.

In one embodiment, the Nostro Agent(s) and client bank(s) may be connected in a “permissioned,” or private network in which only participants in distributed ledger reconciliation may access. In another embodiment, the Nostro Agent(s) and client banks may be in a public network in which entities including those that do not participate in distributed ledger reconciliation may also access.

In one embodiment, client banks may broadcast internal ledger transactions to the network when a payment has been sent and when a receipt has been processed. The Nostro Agents may broadcast nostro transactions to the network as soon as an accounting entry is posted to a nostro account.

When the transactions are matched and validated, they may be “confirmed” and added to the distributed ledger and may be shared with all participants in the network. In one embodiment, the host of the distributed ledger may perform this function.

In one embodiment, the client banks may update their copy of distributed ledger.

If an entry is not confirmed within a reasonable time period, an alert may be sent to the involved Nostro Agent and the client bank.

Embodiments may provide some or all of the following benefits: (1) reduced reconciliation time (e.g., up to one day); (2) reduced cost (e.g., no SWIFT charges); (3) faster error detection and resolution; (4) minimize risks and improve controls on nostro accounts; and (5) easy for any bank to join.

Referring to FIG. 1, a system for account reconciliation using a distributed ledger is disclosed according to one embodiment.

System 100 may include a plurality of financial institutions 110₁-110ₙ, each of which may be, for example, a bank. In one embodiment, one of the financial institutions 110 may be act as an nostro agent for one of the other financial institution 110, and may maintain a separate nostro account for the other financial institution 110. For example, for financial institution 110₁ may maintain a nostro account with one of financial institution 110 which it conducts business.

In one embodiment, each financial institution 110 may conduct transactions in a different currency. For example, financial institution 110₁ may be based in the United States and may conduct transactions in United States Dollars; financial institution 110₂ may be based on Japan, and may conduct transactions in Japanese Yen; financial institution 110₃ may be based in the United Kingdom and may conduct transactions in British Pounds; etc. Thus, financial institutions 110₂ and 110₃ may be thought of as nostro agents for financial institution 110₁.

In one embodiment, financial institutions 110₁-110ₙ may communicate transactions to each other directly, indirectly, etc. In one embodiment, one or more of financial institutions 110₁-110ₙ may communicate transactions using transaction network 130. In one embodiment, transaction network 130 may be the SWIFT network.

In one embodiment, financial institution 110₁ may maintain a mirror nostro account that mirrors each nostro account with other financial institutions 110.

In one embodiment, each financial institution 110 may have backend 150 and distributed ledger 160. For example, each financial institution 110 may maintain its copy of distributed ledger 160. In one embodiment, ledger 160 may be a distributed ledger, such as a Blockchain-based ledger.

In one embodiment, each backend 150 may maintain its associated ledger 160. For example, each back end 150 may write to its copy of distributed leger 160, and may send notifications to other financial institutions 110 based on that activity. For example, when financial institution 110₁ sends a transaction to financial institution 110₂ using transaction network 130, back end 150₁ may write the transaction to its copy of distributed ledger 160₁ and may also communicate the transaction to back ends 150₂-150ₙ to be written to their copies of distributed ledger 160₂-160ₙ.

Referring to FIG. 2, a method for account reconciliation using a distributed ledger is disclosed according to one embodiment. In step 205, a plurality of financial institutions may enroll to participate in a distributed ledger nostro account network. In one embodiment, one financial institution may hold a nostro account for one or more of the other financial institutions.

In step 210, a payment sending financial institution may send a transaction to another financial institution using a transaction network, such as the SWIFT network.

In one embodiment, the transaction may be a payment, a receipt of payment, etc.

In step 215, the payment sending financial institution may write the transaction to its copy of the distributed ledger. In one embodiment, a backend for the payment sending financial institution may write the transaction to the financial institution's copy of the distributed ledger.

In one embodiment, the transaction may be written as a smart contract. For example, the smart contract may include instruction to match ledger entries posted to the distributed ledger network. The smart contract may maintain the opening balance and current running balance of the nostro accounts as part of the reconciliation process. The smart contract may then send alerts to the respective financial institution if a ledger entry cannot be reconciled within a configurable time.

In step 220, the payment sending financial institution may communicate the transaction to other participating financial institutions in the network. In one embodiment, the payment sending financial institution's back end may perform this communication.

In step 225, each financial institution in the network may write the transaction to its copy of the distributed ledger. For example, a backend for each financial institution may write the transaction to its copy of the distributed ledger.

In step 230, the payment receiving financial institution receive the transaction over the transaction network, and in step 235, may write the receipt of the transaction to its copy of the distributed ledger.

In step 235, the receiving financial institution may write the transaction to its copy of the distributed ledger. In one embodiment, a backend for the payment receiving financial institution may write the transaction to the financial institution's copy of the distributed ledger.

In one embodiment, the transaction may be written as a smart contract. The ledger entries written by the payment sending and payment receiving financial institutions may be in same format and may contain the same data elements. The content of the ledger entry written by the payment sending financial institution and the payment receiving financial institution are opposite entries. For example, the payment sending financial institution may write a credit (CR) entry of the nostro account to the ledger network and the payment receiving financial institution may write a debit entry (DR) to the ledger network. The other data attributes—Currency, Amount, Value Date and Transaction Reference, are the same in both entries. The smart contract may match and reconcile the two entries.

In step 240, the payment receiving financial institution may communicate the transaction to other participating financial institutions in the network. In one embodiment, the payment receiving financial institution's back end may perform this communication.

In step 245, each financial institution in the network may write the transaction to its copy of the distributed ledger. For example, a backend for each financial institution may write the transaction to its copy of the distributed ledger.

In step 250, the payment sending and/or payment receiving financial institutions may reconcile their accounts based on the sent/received transaction over the transaction network and the distributed ledger. For example, the nostro agent for a financial institution may update the nostro account, and the financial institution may update its mirror account for the nostro account.

In one embodiment, if there are any discrepancies, between the ledger and the accounts, the financial institution(s) with the discrepancy may take an appropriate action to resolve the discrepancy.

Although several embodiments have been disclosed, it should be recognized that these embodiments are not exclusive to each other.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for account reconciliation using a distributed ledger, comprising:
a payment sending financial institution receiving a transaction involving an account maintained by the payment sending financial institution for a payment receiving financial institution;
the payment sending financial institution communicating the transaction to the payment receiving financial institution using a transaction network;
the payment sending financial institution writing the transaction as a first ledger entry to the payment sending financial institution's copy of a distributed transaction ledger;
the payment sending financial institution receiving a second ledger entry from the payment receiving financial institution; and
the payment sending financial institution reconciling the account using the first ledger entry and the second ledger entry.

2. The method of claim 1, wherein first ledger entry comprises a smart contract.

3. The method of claim 2, wherein the smart contract comprises instructions for the payment sending financial institution to match the first ledger entry to the second ledger entry.

4. The method of claim 2, wherein the smart contract comprises an opening balance for the account.

5. The method of claim 2, wherein the smart contract comprises instructions to alert the sending financial institution in response to a reconciliation failure.

6. The method of claim 1, wherein the first ledger entry comprises a credit entry for the account.

7. The method of claim 1, wherein the second ledger entry comprises a debit entry for the account.

8. The method of claim 1, wherein the account is a nostro account.

9. The method of claim 1, wherein the distributed ledger is a blockchain distributed ledger.

10. A method for account reconciliation using a distributed ledger, comprising:
a payment receiving financial institution receiving a transaction involving an account maintained by a payment sending financial institution for the payment receiving financial institution over a transaction network;
the payment receiving financial institution writing the transaction as a first ledger entry to the payment receiving financial institution's copy of a distributed transaction ledger;
the payment receiving financial institution receiving a second ledger entry from the payment second financial institution; and
the payment receiving financial institution reconciling the account using the first ledger entry and the second ledger entry.

11. The method of claim 10, wherein first ledger entry comprises a smart contract.

12. The method of claim 11, wherein smart contract comprises instructions for the payment sending financial institution to match the first ledger entry to the second ledger entry.

13. The method of claim 11, wherein the smart contract comprises an opening balance for the account.

14. The method of claim 11, wherein the smart contract comprises instructions to alert the sending financial institution in response to a reconciliation failure.

15. The method of claim 10, wherein the first ledger entry comprises a credit entry for the account.

16. The method of claim 10, wherein the second ledger entry comprises a debit entry for the account.

17. The method of claim 10, wherein the account is a nostro account.

18. The method of claim 10, wherein the distributed ledger is a blockchain distributed ledger.
